(19) United States
(12) Patent Application Publication
(10) Pub. No.: US 2024/0081493 A1
(43) Pub. Date: Mar. 14, 2024

(54) REMOVABLE BRACELET COMPRISED WITHIN A PORTABLE OBJECT

(71) Applicant: ETA SA Manufacture Horlogère Suisse, Grenchen (CH)

(72) Inventors: Dohan SCHLICHTIG, Aarburg (CH); Marc SCHENK, Le Landeron (CH)

(73) Assignee: ETA SA Manufacture Horlogère Suisse, Grenchen (CH)

(21) Appl. No.: 18/449,805

(22) Filed: Aug. 15, 2023

(30) Foreign Application Priority Data
Sep. 9, 2022 (EP) 22194856.5

(51) Int. Cl. A44C 5/00; A44C 5/14

(52) U.S. Cl. CPC A44C 5/0053; A44C 5/145

(57) ABSTRACT

A removable bracelet that can be connected to the body of a portable object, the bracelet being provided with a flexible body and including at least one end for fastening the bracelet to this body of the portable object, the fastening end including an attachment area provided with two rigid fastening parts and a deformable part configured to contribute to reversibly fastening the bracelet to the body of the portable object, the deformable part being arranged between the two rigid fastening parts of the area.

### TECHNICAL FIELD OF THE INVENTION

The invention relates to a removable bracelet provided with a flexible or supple body which is reversibly mounted on a body of a portable object such as a timepiece or piece of jewellery.

The invention further relates to such a portable object that comprises such a bracelet.

### TECHNOLOGICAL BACKGROUND

Flexible bracelets for portable objects such as timepieces usually include two strands which are fastened to the case of these timepieces by means of a bar passing through a hole in the bracelet to connect it to the horns of this case. Such a strand can be defined as a segment of the bracelet, at least one end whereof is connected to this case, sometimes via an intermediate part. The other end of each strand can be free, or connected to a bracelet clasp, for example. Single-strand bracelets also exist.

In such a configuration, when a strand must be disassembled or replaced, the bar that connects this strand to the case must be removed. Conventionally, this operation is carried out using a tool known as a “bar tool”, designed to be inserted between the bracelet and the horns of the case. This operation is often difficult for an unaccustomed user, who might scratch the horns or damage the bracelet in this situation. Moreover, it should be noted that in this configuration, such bars are removable bars and are known to be fragile and complex to produce. In this context, it is understood that there is a need to find a solution that in particular overcomes the drawbacks of the prior art.

### SUMMARY OF THE INVENTION

To this end, the invention relates to a removable bracelet that can be connected to the body of a portable object, said bracelet being provided with a flexible body and comprising at least one end for fastening the bracelet to this body of the portable object, said fastening end including an attachment area provided with two rigid fastening parts and a deformable part configured to contribute to reversibly fastening said bracelet to said body of the portable object, said deformable part being arranged between the two rigid fastening parts of said area.

In other embodiments:
each rigid part comprises a gripping area configured to deform the deformable part of the attachment area;
each rigid part comprises a passageway having a through-hole which joins together the inner and outer faces of the bracelet;
each rigid part comprises a passageway provided with a concealed inlet port on an inner face of the bracelet and an outlet port on an outer face of the bracelet;
each rigid part comprises a passageway configured for the insertion of a free end of an instrument for assisting with reversibly fastening the bracelet to the body of the portable object;
said deformable part is configured to vary a defined gap between the two rigid fastening parts;
said deformable part is formed by a region of the flexible body of said bracelet and is provided with a recessed area;
said deformable part is formed by a flexible region of the body of said bracelet and is provided with a recessed area comprising a part of a peripheral wall of the bracelet comprised between the two rigid fastening parts;
each rigid fastening part is formed by a protuberance formed integrally in one piece with the body of said bracelet;
each rigid fastening part comprises a bed in which a hooking element is arranged;
the bracelet comprises at least one strand.

The invention further relates to a portable object comprising a removable bracelet provided with an attachment area configured to procure the reversible fastening of this bracelet to the body of said object.

Advantageously, said object is a timepiece or a piece of jewellery.

### BRIEF DESCRIPTION OF THE FIGURES

One of the aims of the present invention is to provide a removable bracelet for a portable object such as a timepiece, said bracelet correctly combining perfect aesthetics, impeccable fit, great robustness and ease of assembly/disassembly with/from the body of this portable object.

Another aim is to provide a removable bracelet that can be reversibly fastened to the body of this portable object without damaging this object, let alone the bracelet.

Moreover, one of the aims of the invention is also to provide a bracelet having gripping areas used specifically during the assembly/disassembly thereof with/from the body of the portable object, these areas being hidden/concealed within the body of the bracelet.

More generally, one aim of the present invention is to provide a removable bracelet that can be assembled/disassembled with/from the body of the portable object without the limitations of the known solutions.

Other features and advantages of the invention will be better understood upon reading the following detailed description given with reference to the accompanying figures, in which:

FIG. 1 is a perspective view of a portable object such as a timepiece, provided with a removable bracelet according to one embodiment of the invention;

FIG. 2 is a more large-scale view of a part given the reference A in FIG. 1;

FIGS. 3 and 4 are perspective views of a strand of the removable bracelet, one fastening end whereof comprises an attachment area able to cooperate with an attachment part of the body of the portable object, and wherein one surface of this attachment area has a shape/relief that is complementary to that of said attachment part so as to reversibly fasten this strand to the body of the object, according to the embodiment of the invention;

FIG. 5 is a more large-scale view of a part given the reference B in FIG. 4;

FIGS. 6 to 8 are different perspective views of the fastening end comprising the attachment area of this strand of the bracelet, according to the embodiment of the invention;

FIGS. 9 and 10 are perspective views of a strand of the removable bracelet, a fastening end whereof comprises gripping areas, each provided with a concealed inlet port of a passageway provided for inserting a free end of an instrument for aiding/assisting with the reversible fastening of the bracelet to the body of the portable object, according to the embodiment of the invention;

FIG. 11 is a perspective view of a hooking element intended to be arranged within the attachment area of the bracelet, according to the embodiment of the invention;

FIG. 12 is a perspective view of the body of the portable object, in this case a case of the timepiece, this body being provided with the bracelet, the outlet ports whereof, shown here by a dotted line, in its gripping areas, are concealed by the body of this object when the bracelet is assembled with this body, according to the embodiment of the invention;

FIG. 13 is a perspective view of the body of the timepiece provided with the attachment part, here visible from the front, according to the embodiment of the invention;

FIG. 14 is a perspective view of the body of the timepiece provided with the attachment part, here visible from the side, according to the embodiment of the invention, and

FIG. 15 is a more large-scale view of a part given the reference D in FIG. 14.

### DETAILED DESCRIPTION OF THE INVENTION

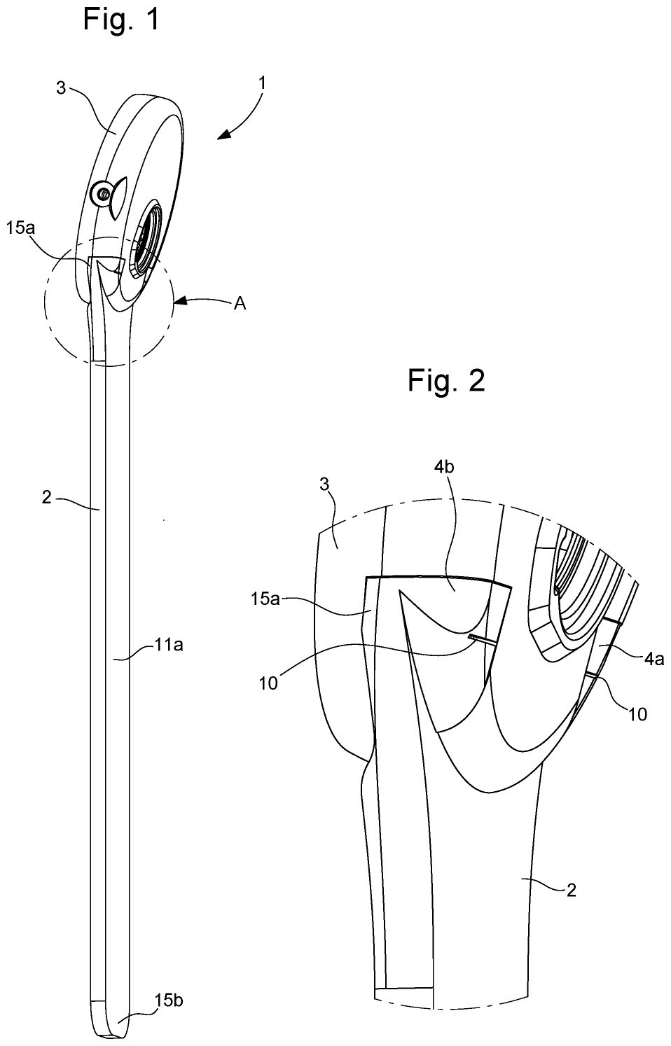

FIGS. 1, 2 and 12 show a portable object 1 such as a timepiece comprising a case 3 and a bracelet 2, one of the strands making up said bracelet 2 being illustrated here. Alternatively, this portable object 1 can be a piece of jewellery/gemstone jewellery or, more broadly speaking, any object 1 that an individual is likely to wear on a part of his/her body, such as on an arm, a leg, the torso or the neck, etc.

As described hereinabove, this bracelet 2 can comprise a strand, as shown in FIG. 1. More specifically, in the embodiment of the invention, such a bracelet comprises at least one strand. The bracelet 2 or said at least one strand has two faces 11a, 11b which are opposite one another, i.e. an inner face 11a and an outer face 11b which is visible when the portable object 1 is worn by the user. These two faces 11a, 11b are joined together by a peripheral wall 8 (visible in several figures including FIG. 4) of this bracelet 2, which further corresponds to the thickness thereof.

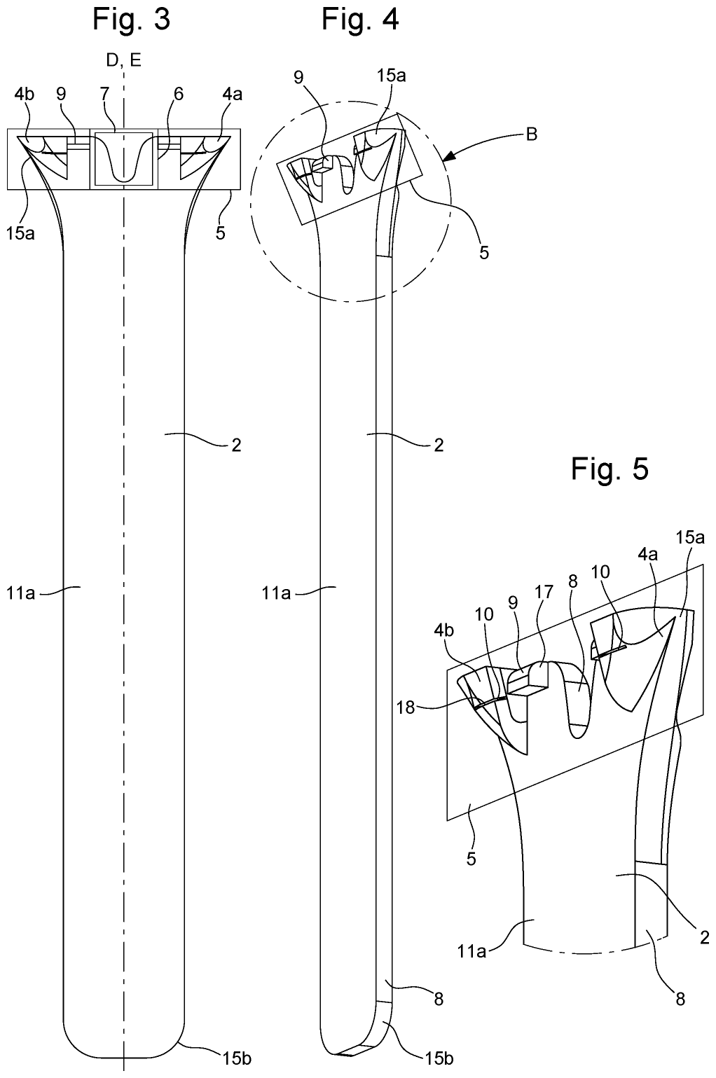

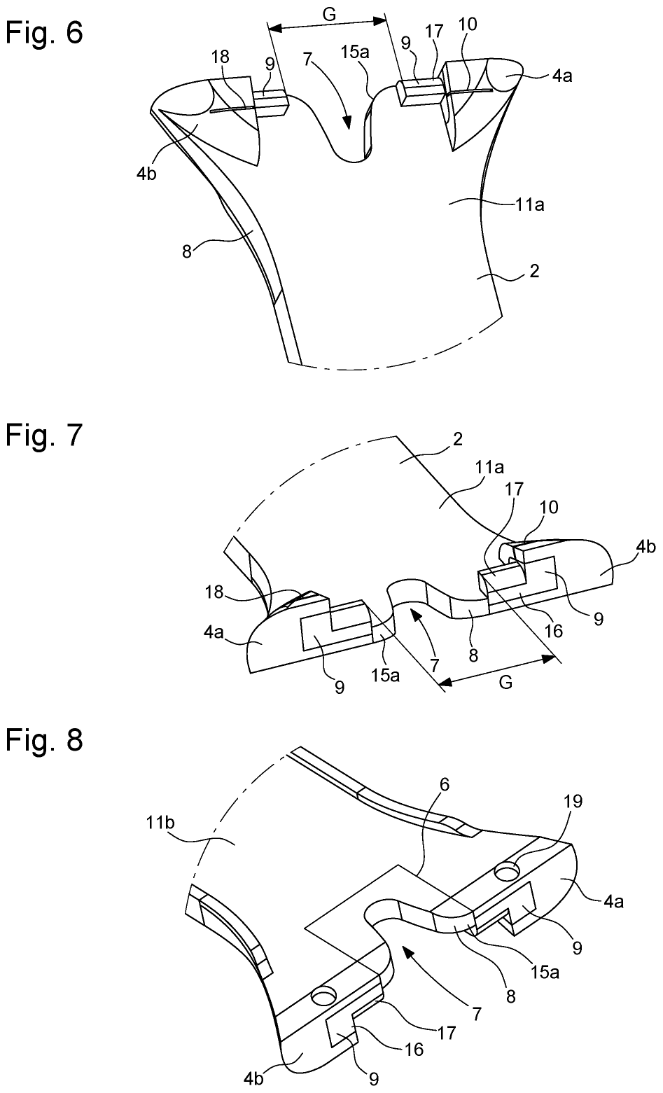

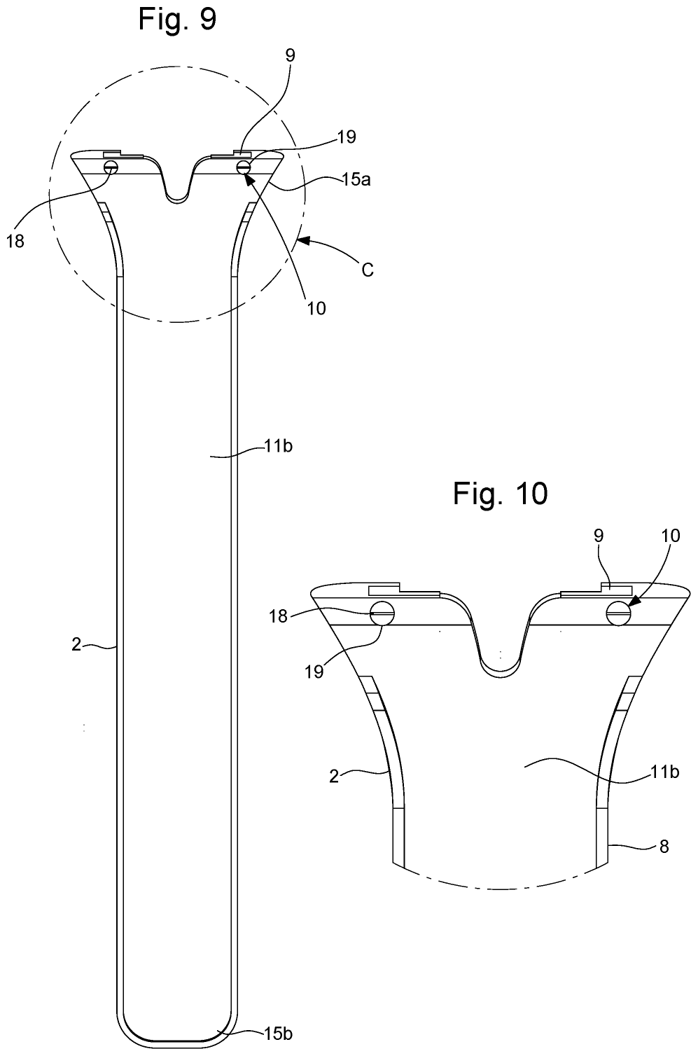

With reference to FIGS. 3 to 10, this bracelet 2 or said at least one strand comprises a body that is wholly or partly flexible or supple. It must be understood here that the entire body of this bracelet 2 is completely flexible/supple, with the exception of the rigid parts 4a, 4b for fastening this bracelet 2, which are provided with rigid hooking elements 9 which will be mentioned hereinbelow. It is understood that when the bracelet 2 is devoid of these hooking elements 9, the body thereof is thus entirely/completely flexible or supple.

Alternatively, this body can be appreciably flexible or comprise a flexible portion. It should be noted that such a body has, in particular, one or more areas 5 for attaching the bracelet 2 to the body 3 of the portable object 1, as will be discussed hereinbelow, the one or more areas being located in a flexible region of this body. Such a body of the bracelet 2 can be made of leather, shagreen, rubber, plastic or any other flexible material.

It is understood that such a bracelet 2 can include two strands when the portable object 1 is a timepiece, as shown in FIG. 1. In this configuration, each strand comprises two ends 15a, 15b:
a first end 15a, referred to as the “fastening end”, which is intended to be fastened/attached/assembled/mounted/connected to the body 3 of the portable object 1, in this case to the case 3, when this object 1 is a timepiece, and
a second end 15b, referred to as the “free end” which is intended to be attached/connected to the free end 15b of the other strand of the bracelet 2 of the portable object 1.

According to an alternative embodiment, this bracelet 2 can be a one-piece part consisting of a single strand, the two ends 15a whereof are fastening ends 15a intended to be fastened to the body 3 of the portable object 1, in this case to the case 3, when this object 1 is a timepiece.

In FIGS. 1, 2, 3 to 8, 9, 10 and 12, the bracelet 2 thus preferably comprises two fastening ends 15a, whether it consists of one or two strands. Each fastening end 15a includes the attachment area 5 mentioned hereinabove. This attachment area 5 is provided with a deformable part 6 and with two rigid fastening parts 4a, 4b. In this area 5, these two rigid parts 4a, 4b are separated by said deformable part 6 configured to contribute to reversibly fastening said bracelet 2 to the body of said object 1. It is thus understood that these two rigid parts 4a, 4b are distinct rigid fastening parts 4a, 4b. These rigid parts are distinct because they are separated by the deformable part 6, which is preferably formed by the flexible body of the bracelet, in particular by a region/portion of this flexible body. It should be noted that in the embodiments of this invention, these distinct rigid parts 4a, 4b are joined together solely by the deformable part 6 and not by any rigid part.

Such an attachment area 5 can be a one-piece part formed integrally in one piece with the body of the bracelet 2. In such a case, the bracelet or the strands making up this bracelet are each a one-piece part.

In this fastening end 15a, the deformable part 6 is formed by the region of the flexible body of said bracelet 2 and comprises a recessed area 7, also referred to as the recessed volume. This recessed area 7 has a shape that is appreciably similar to that of the letter “V” or a flared shape opening onto a peripheral wall 8 of the bracelet 2. In other words, this recessed area 7 comprises part of the peripheral wall 8 located/included between the two rigid fastening parts 4a, 4b. This deformable part 6 is configured to vary a gap G, also referred to as a distance G or an interval G, defined between the two rigid fastening parts 4a, 4b. More specifically, this gap G is defined between active parts 17 of hooking elements 9, described hereinbelow, which are included in these rigid parts 4a, 4b. As will be seen, the variation in this gap G contributes to procuring the removable fastening of the bracelet 2 to the body 3 of the portable object 1.

As mentioned hereinabove, the attachment area 5 comprises two rigid fastening parts 4a, 4b separated by this deformable part 6 which is configured to contribute to reversibly fastening said bracelet 2 to the body 3 of said object. Each rigid fastening part 4a, 4b is formed by a protuberance formed integrally in one piece with the body of said bracelet 2. In other words, each rigid part 4a, 4b protrudes from a part of the inner face 11a of the bracelet 2 included in the attachment area 5. More specifically, each of these rigid parts 4a, 4b is preferably located in a distal part of the fastening end 15a included in the attachment area 5. These rigid parts 4a, 4b are arranged on the inner face 11a of the bracelet 2 equidistant from an axis of symmetry D of this bracelet 2, the axis D extending longitudinally along the body of this bracelet 2. This axis of symmetry D divides this bracelet 2 into two equal parts and is coincident with an axis of symmetry E of the recessed area 7, which also divides this area 7 into two equal parts.

Each rigid part 4a, 4b comprises the hooking element 9 visible, for example, in FIGS. 3 to 11. This hooking element 9 contributes to reversibly fastening the bracelet 2 to the body 3 of the portable object 1. Such a hooking element 9 comprises a part 16 for anchoring this element 9 within the body of the bracelet 2 and in particular within the attachment area 5, and the active part 17, also referred to as the functional part, which hooks/fastens the bracelet 2 to the body 3 of the portable object 1. It should be noted that the anchoring part 16 of this hooking element 9 partially surrounds this active part 17 with which it is formed integrally in one piece. In this respect, the hooking element 9 is a one-piece element which is preferably made of a metal or hard plastic material, or of a rigid composite material.

Each rigid part 4a, 4b is provided with a bed comprising the hooking element 9. More specifically, this bed comprises the anchoring part 16 of this hooking element 9. In this configuration, each rigid part 4a, 4b is preferably overmoulded onto the anchoring part 16 of this hooking element 9. This anchoring part 16 could also be bonded to the inside wall of this bed.

Each rigid fastening part 4a, 4b comprises a gripping area 10, also referred to as a handling area, which is configured to deform the deformable part 6 of the attachment area 5. This deformation of the attachment area 5 is in particular carried out during the fastening/assembly/mounting of the bracelet 2 with the body 3 of the portable object 1. This gripping area 10, which can be seen in particular in FIGS. 3 to 10, comprises a passageway, also referred to as an insertion area. This passageway is formed by a through-hole that joins together the inner and outer faces 11a, 11b of the bracelet 2. This passageway comprises a concealed/masked/hidden inlet port 18 defined on the inner face 11a of the bracelet 2 and an outlet port 19 on the outer face 11b of the bracelet 2. These two ports 18, 19 further constitute the inlet and outlet ports 18, 19 of each gripping area 10 including the corresponding passageway. Such a passageway is configured to allow for the insertion, in the gripping area 10, of a free end of an instrument in order to aid/assist with the reversible fastening of the bracelet 2 to the body 3 of the portable object 1.

Each passageway extends rectilinearly or substantially rectilinearly through the thickness of the bracelet 2 in a direction perpendicular or substantially perpendicular to the longitudinal direction of this bracelet 2 or to the axis of symmetry D of this bracelet 2. This passageway leads:
at one of its two ends, to the inner face 11a of the bracelet 2, tracing, in this face 11a, the inlet port 18 which is a flexible opening having, for example, the shape of a slot comprising flexible lips which are in contact when they are not stressed, i.e. when they are at rest, in order to ensure automatic closure of the corresponding passageway, and
at the other opposite end of the passageway, to the outer face 11b of this bracelet 2, by tracing, in this face 11b, the outlet port 19 which is a preferably circular opening.

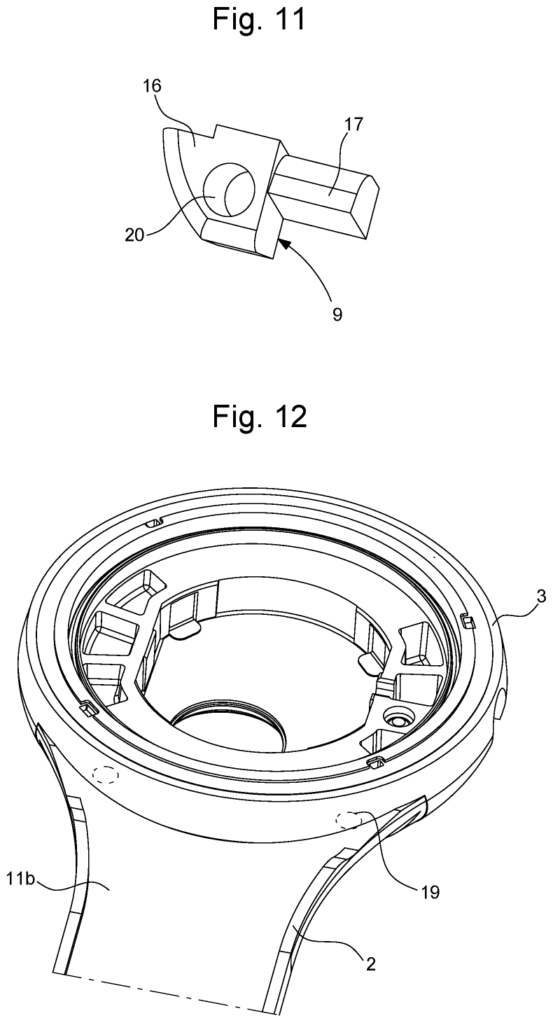

This gripping area 10 is present on the part of the bracelet 2 that comprises the attachment area 5. In this configuration, the passageway of this gripping area 10 passes through the rigid part 4a, 4b so as to join together the inner and outer faces 11a, 11b of the bracelet 2. It is understood that this passageway also passes through the hooking element 9 arranged in this attachment area 5 at a through-opening denoted by the reference numeral 20 in FIG. 11. In other words, this passageway is also formed, among other things, by this opening 20 in the hooking element 9.

In this bracelet 2, the gripping areas 10, in particular the passageway thereof, are configured to receive the free ends of the instrument for aiding/assisting with reversibly fastening the bracelet 2 to the body 3 of the portable object 1. More specifically, the ends of this instrument are inserted into the passageways of these gripping areas 10 via the inlet port 18 thereof. Within the scope of this insertion, these ends are guided towards the gripping areas 10 so as to be inserted into the inlet ports 18, in this case the slots 18, which are concealed in the body of the bracelet 2. Such an insertion into this slot 18 causes the lips of this slot 18 to spread apart and continues until this end reaches and passes through the outlet port 19 of this passageway (or of the gripping area 10), in this case the opening 19, to emerge at the outer face 11b of the bracelet 2.

Once these free ends are arranged in the gripping areas 10, the instrument then contributes to the handling/inspection of the attachment area 5 relative to the case 3 when being fastened to this case 3. More specifically, when used, this instrument contributes to generating/causing the deformation of the deformable part 6 of the attachment area 5 in order to reversibly fasten this bracelet 2 to the case 3.

It should also be noted that once these free ends have been removed from the inlet ports 18, the lips of the slots close again, thus masking the passageways. This particular feature of these slots 18 preserves the aesthetic properties of the bracelet 2 by concealing the presence of the passageways and thus of the gripping areas 10, in other words by concealing the inlet port 18 of each passageway. Such a feature also helps to prevent the bracelet 2 from being disassembled by an individual who is not aware of the precise location of these passageways in the bracelet 2 and thus of the gripping areas 10. In other words, such a feature helps to prevent a child from being able to disassemble the bracelet 2 by himself/herself by identifying the gripping areas 10, which could lead to serious consequences such as the child swallowing this bracelet 2 or elements that may make it up.

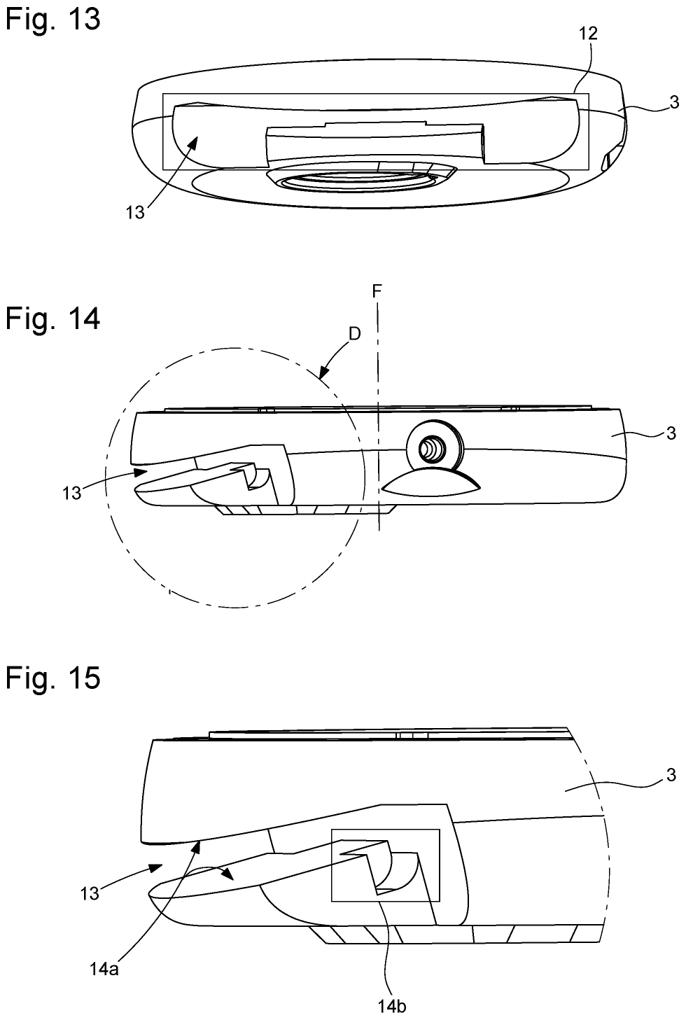

With reference to FIGS. 1, 2 and 12 to 15, the portable object 1 comprises an attachment part 12 configured to cooperate with the attachment area 5 of the removable bracelet 2 within the scope of the fastening of this bracelet 2 to the body 3 of this object 1. The attachment part 12 and the attachment area 5 each have a surface whose shape/relief is complementary to that of the surface of the other, so as to ensure optimum cooperation of one with the other for fastening the bracelet 2 to the body 3 of the portable object 1. In other words, the surface of the attachment part 12 has a shape/relief that is complementary to the shape/relief of the surface of the attachment area 5.

This attachment part 12 of the body 3 of the portable object 1, in this case the case 3 of a timepiece 1, comprises a bed 13 which is configured to receive the attachment area 5 of the bracelet 2. This bed 13 is formed wholly or partly by the surface of this attachment part 12. Such a bed 13 includes:
a first part comprising walls 14a parallel or substantially parallel to one another, and capable of:
   guiding the arrangement of the corresponding attachment area 5 in this bed during the fastening/assembly/mounting of the bracelet 2 with the body 3 of the portable object 1 and,
   contributing to keeping this attachment area 5 in the bed when the bracelet 2 is fastened to the body 3 of the portable object 1,
   masking, hiding, concealing the outlet ports 19 of the gripping areas 10 of the bracelet 2, and
a second part comprising cavities 14b, forming hooking areas, configured to receive and cooperate with the active parts 17 of the hooking elements 9 of the attachment area 5 within the context of fastening the bracelet 2 to the body 3 of the portable object 1.

It should be noted that when the portable object 1 is a timepiece, it preferably comprises two attachment parts 12 defined in a peripheral wall of this case 3. In such a case 3, these attachment parts 12 are arranged opposite one another and equidistant from an axis of revolution F of this case 3.

Thus, in one of the embodiments, the invention relates to a removable bracelet 2 that can be connected to the body 3 of the portable object 1, said bracelet 2 being provided with a flexible body and comprising at least said end 15a for fastening the bracelet 2 to this body 3 of the portable object 1, said fastening end 15a including the fastening area 5 provided with the two distinct rigid fastening parts 4a, 4b and the deformable part 6 formed by a region/portion of the flexible body of the bracelet, said part 6 being configured to contribute to reversibly fastening said bracelet 2 to said body 3 of the portable object 1. In this context, the deformable part 6 is arranged between the two rigid parts 4a, 4b of said area 5 and/or this deformable part 6 separates the two rigid parts 4a, 4b of this area 5.

It should also be noted that one embodiment of the invention further relates to a system for fastening the bracelet 2 to the body 3 of the portable object 1. In addition to the portable object 1 and its bracelet 2, this system comprises the instrument for handling the attachment area 5 of the bracelet 2 relative to the attachment part 12 of the body 3 of the portable object 1 during operations for assembling (or disassembling) the bracelet 2 to (from) the body 3 of the object 1.

In this system, the free ends of this instrument are inserted into the gripping areas 10 of the attachment area 5 of the bracelet 2 and a force is then applied to this instrument in order to cause these free ends to move apart and thus increase the gap G defined between the two active parts 17 of the hooking elements 9 included in the rigid fastening parts 4a, 4b of the attachment area 5 of the bracelet 2. In this configuration, the attachment area 5 can thus be easily inserted into or extracted from the corresponding attachment part 12 of the body 3 of the portable object 1, without the rigid parts 4a, 4b and in particular the hooking elements 9 abutting against the surface of the bed for the attachment part 12.

It should also be noted that when the bracelet 2 is removably fastened to the body 3 of the portable object 1, each attachment area 5 of the bracelet 2 is arranged in the corresponding attachment part 12 of the body 3 of the portable object 1. In this configuration, the gripping areas 10 and in particular the outlet ports 19 of the passageway of each of these gripping areas 10 are concealed in the body of the portable object 1. With reference to FIG. 12, when the portable object 1 is a timepiece, each outlet port 19 of the gripping area 10 is concealed in a middle of the case 3 of this timepiece 1.

In the embodiment described, the bracelet 2 is directly and removably fastened to the body 3 of the portable object 1, with each attachment area 5 of the bracelet 2 being positioned in the corresponding attachment part 12 of the body 3 of the portable object 1.

In an alternative embodiment not shown in the figures, this bracelet 2 can be fastened indirectly yet still removably to the body 3 of the portable object 1 by means of attachment elements connected to the body 3 of the portable object 1. More specifically, the portable object comprises two attachment elements, each comprising a first end fastened to this body and a second end comprising an attachment part similar to the attachment part denoted by the reference numeral 12 mentioned hereinabove. In this configuration, each attachment area 5 of the bracelet 2 can thus be arranged in the attachment part of the corresponding attachment element. In this context, it should be noted that when the portable object is a timepiece, each attachment element is connected to the horns of the case via the first end thereof. Finally, it should be noted that this attachment element can be appreciably flexible or semi-rigid.

It goes without saying that the present invention is not limited to the embodiment described hereinabove and that various simple alternatives and modifications can be considered by a person skilled in the art without leaving the scope of the invention as defined by the accompanying claims.

1. A removable bracelet that can be connected to the body of a portable object, said bracelet being provided with a flexible body and comprising at least one end for fastening the bracelet to said body of the portable object, said fastening end including an attachment area provided with two rigid fastening parts and a deformable part configured to contribute to reversibly fastening said bracelet to said body of the portable object, said deformable part being arranged between the two rigid fastening parts of said area.

2. The removable bracelet according to claim 1, wherein each rigid part comprises a gripping area configured to deform the deformable part of the attachment area.

3. The removable bracelet according to claim 1, wherein each rigid part comprises a gripping area configured to deform the deformable part of the attachment area, said rigid part comprising a passageway having a through-hole which joins together the inner and outer faces of the bracelet.

4. The removable bracelet according to claim 1, wherein each rigid part comprises a passageway provided with a concealed inlet port on an inner face of the bracelet and an outlet port on an outer face of the bracelet.

5. The removable bracelet according to claim 1, wherein each rigid part comprises a passageway configured for the insertion of a free end of an instrument for assisting with reversibly fastening the bracelet to the body of the portable object.

6. The removable bracelet according to claim 1, wherein said deformable part is configured to vary a defined gap between the two rigid fastening parts.

7. The removable bracelet according to claim 1, wherein said deformable part is formed by a region of the flexible body of said bracelet and is provided with a recessed area.

8. The removable bracelet according to claim 1, wherein said deformable part is formed by a flexible region of the body of said bracelet and is provided with a recessed area comprising a part of a peripheral wall of the bracelet comprised between the two rigid fastening parts.

9. The bracelet according to claim 1, wherein each rigid fastening part is formed by a protuberance formed integrally in one piece with the body of said bracelet.

10. The removable bracelet according to claim 1, wherein each rigid fastening part comprises a bed in which a hooking element is arranged.

11. The removable bracelet according to claim 1, wherein the removable bracelet comprises at least one strand.

12. The removable bracelet according to claim 1, wherein the two rigid parts are separated by the deformable part which is formed by a region of the flexible body of the bracelet.

13. A portable object comprising a removable bracelet according to claim 1, said bracelet comprising an attachment area configured to procure a reversible fastening of said bracelet to the body of said object.

14. An object according to claim 13, wherein the object is a timepiece or a piece of jewellery.
